(19) United States
(12) Patent Application Publication
(10) Pub. No.: US 2001/0003393 A1
(43) Pub. Date: Jun. 14, 2001

(54) MULTI-COMBINATION VEHICLE INCORPORATING AN ELECTRONICALLY COUPLED POWER TRAILER

(75) Inventor: JAMES W. COOPER, CULLEN BAY CRES DARWIN NT (AU)

Correspondence Address: BRADLEY D BECK, GARRISON MORRIS & HAIGHT PLLC, 5100 POPLAR AVENUE, SUITE 2100, MEMPHIS, TN, 38137

(73) Assignee: James W. Cooper

(21) Appl. No.: 09/418,080

(22) Filed: Oct. 14, 1999

(30) Foreign Application Priority Data
Oct. 14, 1998 (AU) PP6487

(51) Int. Cl. B60D 1/00; B62D 53/00; B62D 53/06

(52) U.S. Cl. 280/411.1; 280/423.1

(57) ABSTRACT

The present invention is for a multi-combination vehicle including a prime mover having an engine and at least one powered trailer mechanically coupled to the prime mover. A control system measures the relative motion or force between the two, preferably by the use of a load cell and accordingly adjusts the operation of the engine on the power trailer so that the powered trailer and the prime mover are synchronized in their movement. This allows a multi-combination vehicle to carry a significant load, by providing sufficient motive power without the potential for damage to the transmission and differential system of the prime mover.

The present invention relates to an over-the-road multi-combination vehicle where the power-to-weight ratio of the vehicle is maintained at an acceptable level through the use of an additional or secondary motive power source or engine to the one primary found in the vehicle and that is operatively coupled to the primary one.

### BACKGROUND OF THE INVENTION

Over-the-road multi-combination vehicles are well known and include a prime mover coupled to a plurality of trailers and converter dollies. Typically these vehicles have a single power source and are limited in gross combination mass to 200-230 tonnes.

In some circumstances it is highly desirous that vehicles with greater tonnage and/or better control be used. To this end there have been several proposals of vehicles where there is an increase in its traction, including hydraulically driven axles and mechanically linked axles whilst using a single power source. Other proposals have included the use of a completely separate engine placed on the dolly. However, a satisfactory solution to the problem of matching the engine speeds of the prime mover and power dolly has not yet been proposed leading to the problem that the power dolly may jackknife and be difficult to control when braking.

Multi-combination vehicles for dedicated road haulage tasks such as mineral concentrate haulage are currently operating at Gross Combination Mass (GCM) up to 230 tonnes. However, there is a practical limit to the GCM of the multi-combination vehicle with a single prime mover. The cost of haulage is determined mainly on weight. If one can therefore increase the total haulage that can be moved by a single prime mover that does not require additional operators, the cost benefit is substantial.

It is an object of the present invention to overcome some of the abovementioned problems or to at least provide the public with a useful alternative by providing for a prime mover with two motive power sources.

Accordingly the present invention discloses an additional motive power source for use with a prime mover, advantageously placed on a trailer and that is operatively coupled to the prime mover. The use of the electronically coupled power trailer maintains the power-to-weight ratio of the mover or vehicle at an acceptable level. This allows the vehicle to maintain sufficient road speed at GCMs well above the current practical limit for a single prime mover and hence improve the overall efficiency and productivity of the transportation system.

### SUMMARY OF THE INVENTION

Therefore in one aspect of the invention there is proposed a multi-combination vehicle including;

a prime mover including a first power source located on said prime mover;

a trailer mechanically coupled to said prime mover and including a second power source located on said trailer; and

a control means adapted to operatively couple the first and second power sources.

In a further aspect of the invention there is proposed a multi-combination vehicle including;

a prime mover including a first power source located on said prime mover;

a dolly mechanically coupled to said prime mover and including a second power source located on said dolly; and

a control means adapted to couple the first and second power sources.

In a yet further aspect of the invention a multi-combination vehicle includes:

a prime mover including a plurality of wheels, at least some of the wheels caused to rotate by a first power source located on said prime mover to thereby move the prime mover at a first speed;

a trailer mechanically coupled to said prime mover and including a plurality of trailer wheels wherein at least some of the trailer wheels are caused to rotate by a second power source located on said trailer to thereby move the trailer at a second speed; and

at least one control means including at least one sensor to sense the motion of the prime mover and the trailer and effect a control of at least one of the power sources to thereby cause the motions of the prime mover and the trailer to be substantially the same.

In preference the sensor is a load cell, and which senses the force exerted by the power trailer on the prime mover, the control means operatively controlling the second power source in response to that force, so that the load on the load cell is within a pre-determined range.

In preference said vehicle includes a plurality of non-powered trailers, at least one said non-powered trailer mechanically coupled between said prime mover and said power trailer.

In preference said vehicle includes a plurality of non-powered trailers, said non-powered trailers mechanically coupled to the power trailer.

Preferably said multi-combination vehicle further includes a control system adapted to receive input from load cell operatively coupling the prime mover and the power trailer, and a plurality of sensors on both the prime mover and the power trailer, said sensors including engine management system sensors and driveline system sensors, said control systems operating said power trailer engine to synchronise the operation of the engines on the prime mover and the power trailer.

Preferably said vehicle further includes hydraulic dampeners on said power trailer.

Preferably said vehicle includes an articulation sensor and a control system that activates the hydraulic dampeners in response to the alignment of the power trailer to the prime mover to keep the alignment within a pre-determined range.

The control systems accordingly operatively (by electronic means) couples the engine management system and the driveline control system of the prime mover to the engine management and driveline control system of the power trailer. The systems monitor the engine speed and gear on the power trailer to be automatically matched to the prime mover.

In the event that the prime mover and power trailer are experiencing different sets of road conditions, which could cause the power trailer drive wheels to lose traction, a traction control system will automatically reduce the engine power output of the power trailer. Likewise if the prime mover has lost traction or the power trailer produces excessive load on the forward coupling the system will automatically reduce the engine power output of the power trailer.

Since excessive tractive effort by the power trailer could cause interference with the forward trailer or trailers and could lead to the multi-combination vehicle becoming unstable, the control systems may also be adapted to sense of fore-aft load at the trailer coupling and control of the tractive effort at the power trailer. In the extreme event that the power trailer does become unstable, hydraulic actuators may be used to realign the power trailer with the forward trailer.

### DESCRIPTION OF DRAWINGS

To further assist in understanding the invention reference is made to the drawings in which like numerals are used to indicate like elements.

FIG. 1 is a side elevation drawing of a multi-combination vehicle incorporating a power trailer according to the present invention;

FIG. 2 is a perspective view of a power trailer;

FIG. 3 is a side elevation drawing of a power trailer;

FIG. 4 is a plan drawing of a power trailer;

FIG. 5 is a front view of a power trailer; and

FIG. 6 is a schematic plan of a control system operatively controlling the prime mover with the power trailer.

### DESCRIPTION OF THE PREFERRED EMBODIMENT

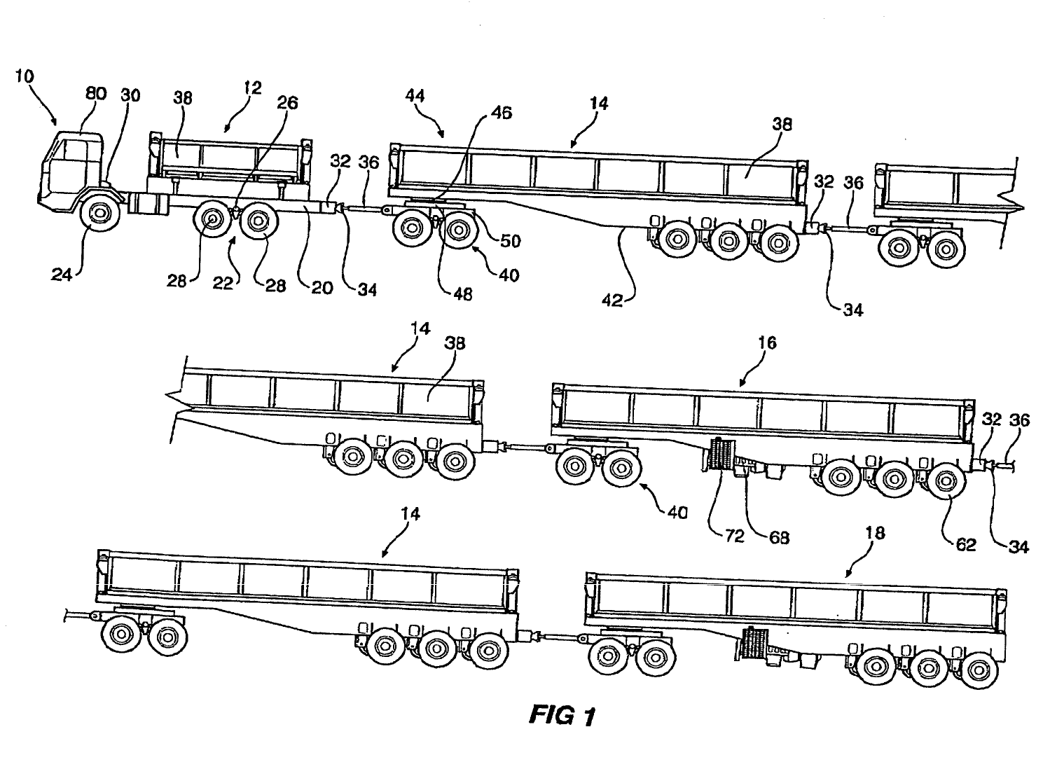

Turning now to the drawings in detail there is shown in FIG. 1 a multi-combination vehicle 10 including a prime mover 12 mechanically coupled to a plurality of trailers 14. A power trailer 16 extends from forwardly located trailers 14 and a further trailer 14 is coupled to the power trailer 16. A second power trailer 18 is coupled to the last trailer 14. It is however to be understood that the multi-vehicle combination may be one or more power trailers, depending on the application.

The prime mover 12 includes a chassis or frame 20 and a rear axle assembly 22, which is suspended from and disposed below the chassis 18. Forward axle 24 comprises the steering axle of the prime mover 12. The rear axle assembly 22 is suspended from chassis 18 via an air suspension 26 and includes wheeled axles 28. Both of the wheeled axles may be driving axles, or alternatively only one is a driving axle. The driving axles may be a tridem axle assembly in lieu of the tandem axle assembly 22 and possibly suspended with a mechanical suspension.

The prime mover 12 further includes a motive power source 30 and a transmission (not shown) for transmitting torque from the motive power source 30 to the drive axles 28. Typically the source of motive power comprises a diesel engine and the transmission for transmitting torque from the engine 30 to the drive axles 28 includes a gear box, a drive shaft and a differential (not shown). Alternatively, the source of the motive power 30 may comprise other types of internal combustion engines utilising a variety of fuels. As yet another alternative the source of motive power 30 may comprise an electric motor with the transmission transmitting torque comprising a suitable coupling interconnecting the electric motor and axle assembly 22.

The prime mover further includes a draw frame 32 attached to and rearwardly extending from the chassis 20. A coupling 34 is attached to the rear of the draw frame and connected with a drawbar 36 on the trailer. A bin 38 accommodates payload to be carried by the prime mover and may be adapted to be side-tipping by hinge means (not shown) attached to the frame 20.

Each of the trailers 14, and each of the power trailers 16 and 18, includes a converter dolly 40 and a semi-trailer 42, having a forward end with a coupling system 46 that pivotably attaches to a ball-race turntable 48 on the converter dolly. This enables the converter dolly to pivot relative to the semi-trailer about a generally vertical axis of rotation passing through the centre of the ball-race turntable. Other embodiments may however equally well be used, such as an oscillating ball-race turntable. The drawbar 36 is hingedly connected to the chassis 50 of the converter dolly 40 and accommodates for any change in the grade of the road surface. As with the prime mover, the trailer further includes a draw frame 32 attached and rearwardly extending from the chassis 52. A coupling 34 is attached to the rear of the draw frame 32 and is connected with a drawbar 36 on the next trailer or power trailer. A bin 38 accommodates payload to be carried by the trailer and may be adapted to be side-tipping by hinge means (not shown) attached to the frame 52.

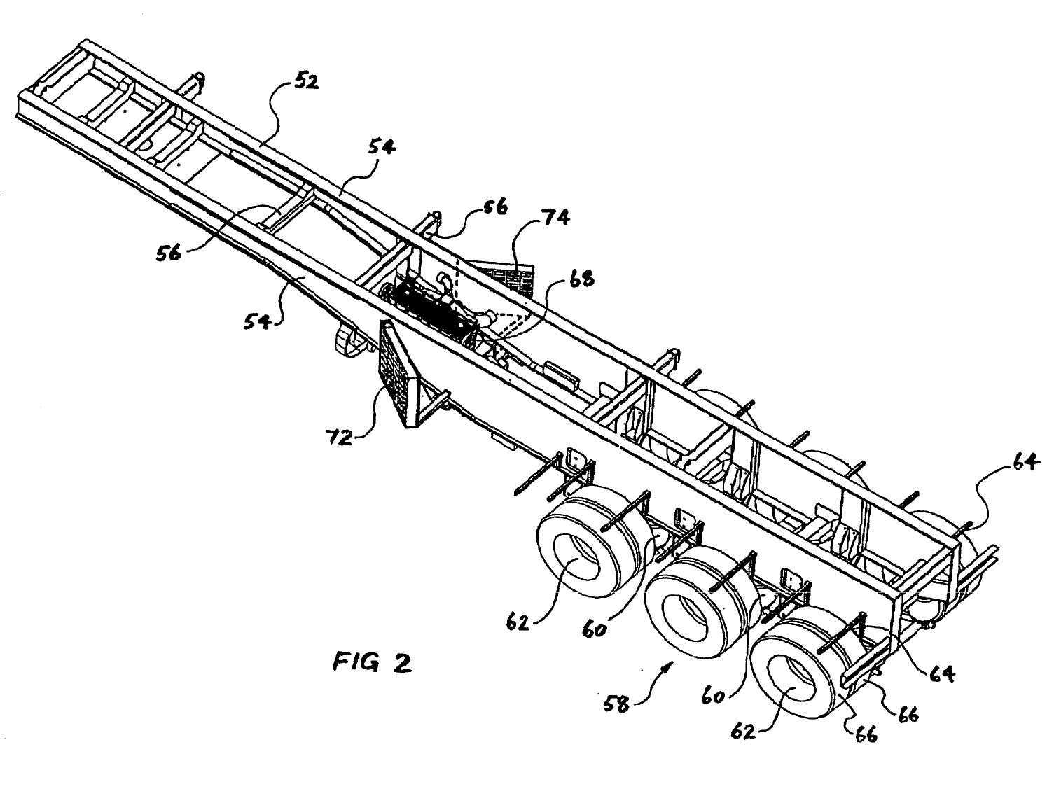

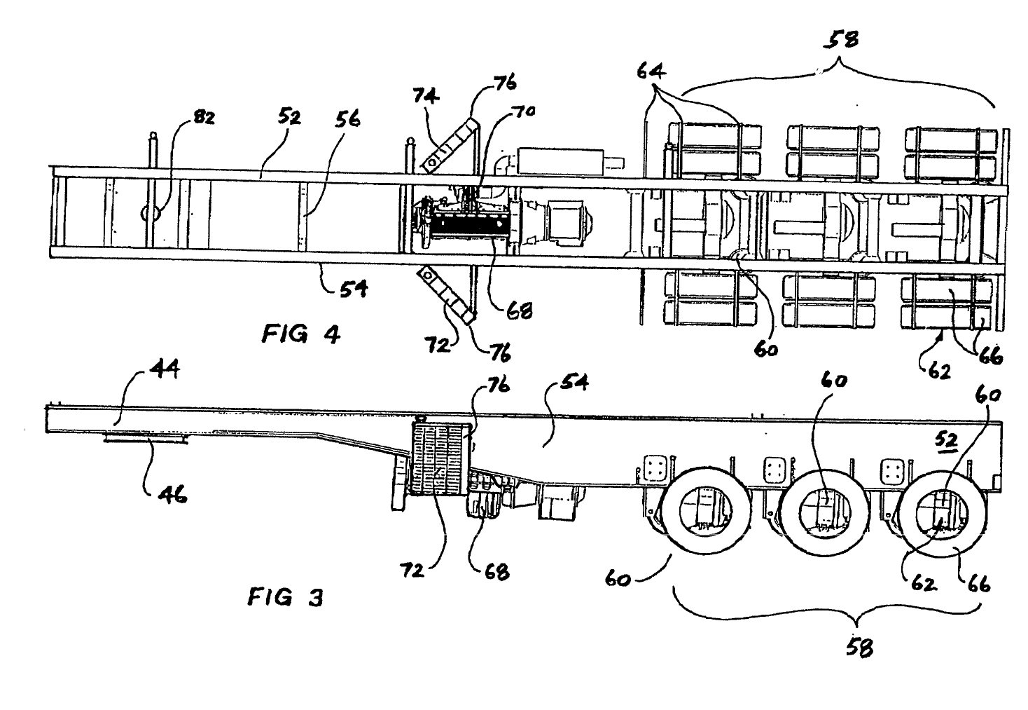

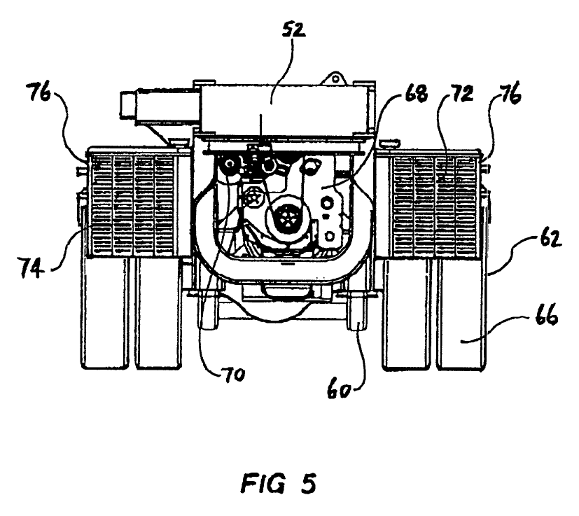

Referring to FIGS. 2-5, the semi-trailer 42 of the power trailer 16 includes a chassis or frame 52 which may include a pair of longitudinally extending side members 54 and a plurality of transverse cross-members 56 interconnecting and attached to the side members 54. The semi-trailer includes a rear axle assembly 58 that is suspended from chassis 52 by air suspension 60. Alternatively the semi-trailer 42 may include a conventional mechanical spring assembly. The side members support or form part of the load carrying structure such as bin 38. The load carrying structure may be a side tipping trailer, a stock crate, a fuel tank or any other type of structure for supporting a load. As with the prime mover and the trailer, the power trailer further includes a draw frame 32 attached and rearwardly extending from the chassis 52. A coupling 34 is attached to the rear of the draw frame 32 and connected with a drawbar 36 on the next trailer or power trailer. A bin 38 accommodates payload to be carried by the power trailer and may be adapted to be side-tipping by hinge means (not shown) attached to the frame 52.

The rear axle wheel assembly 58 includes wheeled axles 62. Extending above said wheeled axles are members 64 that may be used to support mudguards and the like (not shown). In an alternative the axle assembly may be a tandem assembly in lieu of the tridem axle assembly. The wheeled axles include a plurality of tires 66 mounted thereon for supporting the semi-trailer as it travels over a road surface.

Mounted below the upper surface of the chassis 52 is a motive power source or engine 68 positioned generally centrally between the side members 54 and the chassis. A transmission (not shown) provides driving power from the engine to the axle assembly 58 where one or more of the wheeled axles 62 may be driven. The engine is typically a diesel engine and may advantageously include a turbocharger 70. To be able to fit the engine in between the side members, the spatial distance between the two is generally larger than that conventionally found on existing semi-trailers. However, the standard width of the wheeled axles had to be kept the same to keep the vehicle roadworthy. This has necessitated mounting the suspension 60 under said side members rather than on their side.

The engine 68 includes a radiator 72 to assist in cooling the engine through a typical fluid means. The turbocharger 70 includes an air cooling unit 74 that assist in cooling the air that is then injected into the engine. In a conventional cooling system the radiator and air cooler are mounted at the front of the vehicle, which is not possible in the power trailer. To achieve a sufficient flow through of air through the radiator 72 and air cooler 74 on the power trailer 14, the radiator 72 and the air cooler 74 are positioned externally of said side members 54, with the outer edge 76 of the radiator and air cooler not extending beyond the outer extent of the wheeled axles (seen clearly in FIG. 5). This provides protection for the radiator and the air cooler. Depending on the capacity of the engine, a minimum square area of the radiator and air cooler is required. Typically, each horse power of the engine requires around 10 square centimeters of radiator and air cooler area. To achieve this in the space provided both the radiator and the air cooler are positioned at an angle to the longitudinal axis of the side members 54, the total angle depending on the size of the radiator and air cooler required for the size of the engine.

The engine 68 on the power trailer is controlled by the control system 78 that is generally mounted in the cab 80 of the prime mover. A load cell 82 is located in the coupling system 46 that monitors a load in the longitudinal direction of the power trailer 16 and effects an output of that condition in the form of a electronic signal that is monitored by control system 78. In the most simple form, the control system included a throttle control mechanism that controls the throttle of the engine on the power trailer and a transmission control mechanism that controls the engagement of the transmission to the drive axles. If the load cell indicates that the power trailer is exerting a large undesirable force on the prime mover, the control system reduces the throttle of the power trailer engine and thus the power on the power trailer. Conversely, if the load cell finds very little load, that is, the prime mover is essentially pulling the power trailer, the throttle is increased until the power motion of the power trailer is relatively self-propelling. During initial take-off, the control system directs the power trailer transmission to engage whilst increasing the throttle in line with that on the prime-mover.

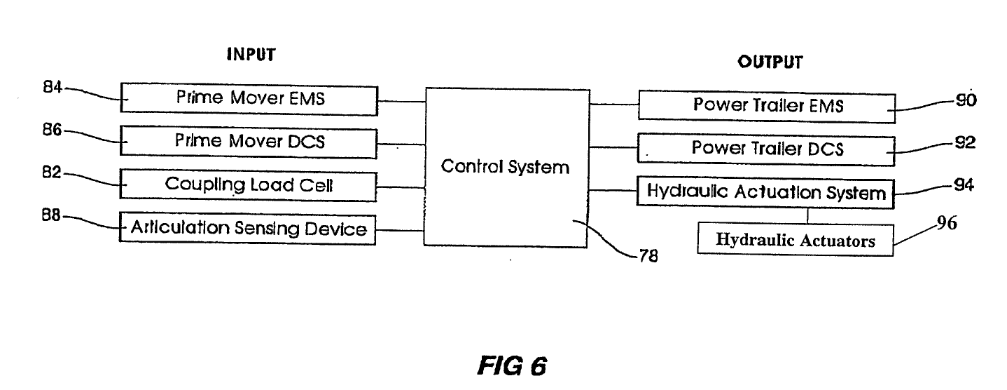

A more sophisticated control system may be employed. Referring to FIG. 6 the control system 78 thus may receive input signals from the prime mover engine control or management system (EMS) 84, driveline control system 86, the power trailer coupling load cell 82 and an articulation sensing device 88 discussed below. The input signals are processed electronically and generate output signals. The output signals from the control system 78 are operatively connected to the power trailer 16 and in particular to the power trailer engine management system 90, driveline control system 92, and a hydraulic actuation system 94 that controls hydraulic actuators 96.

As briefly mentioned above the power trailer 16 may further include a pair of hydraulic actuators 96 that can align the power trailer 16 in the event that it becomes unstable. A sensor (not shown) may be adapted to sense the articulation angle of the power trailer relative to the forward trailer or prime mover and effect a signal that is monitored by the control system 78 which activates, if necessary, according to pre-determined criteria, the actuators 96 to realign the power trailer.

Thus one can see that the present invention teaches a multi-combination vehicle consisting of a powered prime mover, at least one powered trailer and which may include a number of non-powered trailers. The powered trailer is electronically coupled to the powered prime mover. By using one or a plurality of power trailers or secondary movers, that are electronically coupled to the prime mover, one may increase the gross combination mass. A control system ensures that the power trailer will not become unstable due to power jackknife. The control system electronically couples the Engine Management Systems (EMS) and Driveline Control System (DCS) of the power trailer and prime mover, may further incorporate traction control, may also monitor the forward coupling load and activate hydraulics to dampen any amplified yaw motion of the power trailer.

By ensuring that the operation of the engines on the prime mover and the powered trailer are synchronised, the problems of take-off of a fully loaded vehicle are reduced, as is the potential damage to transmissions and differentials.

Whilst the foregoing description has set forth the preferred embodiments of the present invention in some detail, it is to be understood that numerous modifications, obvious to a person skilled in the art, may be made without departing from the scope of the invention as defined by the ensuing Claims. It is therefore to be understood that the invention is not limited to the specific embodiments as herein described.

The claims defining the invention are as follows:

1. A multi-combination vehicle including;
a prime mover including a first power source located on said prime mover;
a trailer mechanically coupled to said prime mover and including a second power source located on said trailer; and
a control means adapted to operatively couple the first and second power sources.

2. A multi-combination vehicle including;
a prime mover including a first power source located on said prime mover;
a dolly mechanically coupled to said prime mover and including a second power source located on said dolly; and
a control means adapted to couple the first and second power sources;

3. A multi-combination vehicle including;
a prime mover including a plurality of wheels, at least some of the wheels caused to rotate by a first power source located on said prime mover to thereby move the prime mover at a first speed;
a trailer mechanically coupled to said prime mover and including a plurality of trailer wheels wherein at least some of the trailer wheels are caused to rotate by a second power source located on said trailer to thereby move the trailer at a second speed; and
at least one control means including at least one sensor to sense the motion of the prime mover and the trailer and effect a control of at least one of the power sources to thereby cause the motions of the prime mover and the trailer to be substantially the same.

4. A multi-combination vehicle as in claim 3 wherein the sensor is a load cell, and which senses the force exerted by the power trailer on the prime mover, the control means operatively controlling the second power source in response to that force, so that the load on the load cell is within a pre-determined range.

5. A multi-combination vehicle as in claim 3 wherein said vehicle includes a plurality of non-powered trailers, at least one said non-powered trailer mechanically coupled between said prime mover and said power trailer.

6. A multi-combination vehicle as in clam 3 wherein said vehicle includes a plurality of non-powered trailers, said non-powered trailers mechanically coupled to the power trailer.

7. A multi-combination vehicle as in claim 3 further including a control system adapted to receive input from load cell operatively coupling the prime mover and the power trailer, and a plurality of sensors on both the prime mover and the power trailer, said sensors including engine management system sensors and driveline system sensors, said control systems operating said power trailer engine to synchronise the operation of the engines on the prime mover and the power trailer.

8. A multi-combination vehicle as in claim 3 further including hydraulic dampeners on said power trailer.

9. A multi-combination vehicle as in claim 8 wherein said vehicle includes an articulation sensor and a control system that activates the hydraulic dampeners in response to the alignment of the power trailer to the prime mover to keep the alignment within a pre-determined range.
